(19) United States
(12) Patent Application Publication
(10) Pub. No.: US 2006/0024408 A1
(43) Pub. Date: Feb. 2, 2006

(54) Nutrition bar for adolescent consumers

(76) Inventor: Matthew Andrew Cicci, Manlius, NY (US)

Correspondence Address: Dennis H. Rainear, 13400 College Valley, Richmond, VA, 23233-7643, US

(21) Appl. No.: 10/909,448

(22) Filed: Aug. 2, 2004

(51) Int. Cl. A23L 1/30

(52) U.S. Cl. 426/72

(57) ABSTRACT

The present invention provides a nutrition bar or health food bar designed to meet both the RDA requirements of vitamins and minerals for teenagers and the taste preferences of the teenage consumer.

### FIELD

The present invention is broadly concerned with a solid nutritional food, such as for example, bars or cubes, and methods of making the same. More particularly, the invention pertains to food compositions which can be formulated to provide 100% of the recommended daily allowances (“RDA”) of various vitamins, minerals, and other supplements for teenagers and adolescents.

### BACKGROUND

Human nutritional bars, diet supplement bars, health bars, and the like, have been introduced which provide a portion of the minerals and vitamins recommended by the U.S. Government for good health. However, these bars have generally been high in moisture, resulting in a limited shelf life. Furthermore, these bars often do not contain 100% of the RDA for humans (particularly teenagers also referred to herein as adolescents) of vitamins, minerals, and other essential or beneficial nutrients and supplements, or have an unacceptable taste or texture. In addition, these products do not contain varying levels of particular vitamins or minerals to compensate for deficiency of a certain vitamins or minerals in a particular person based on age and/or gender. Thus, a teenage person with a calcium or vitamin E deficiency receives the same quantity of calcium or vitamin E from the prior art nutritional bars as a person who does not need additional calcium or vitamin E in his or her diet. Finally, many of the prior art bars have an unappealing taste, thus causing many teenagers to avoid them.

KIDSPORT® Nutrition Bar is a snack food for children and young teens marketed by Good Natured Products, Inc. The products, however, are not directed to teenagers over the ages of 14, and they contain 5-6 grams of fat per bar.

Cliff Bar produces a product called “Z Bar” targeted toward young consumers, but the product is quite different from the present invnetion.

Conventional “energy bars” tend to claim to contain more carbohydrate, while “diet bars” (also called “weight loss” bars) generally claim to contain fewer carbohydrates. Candy bars, while possessing an attractive taste to teenage consumers, generally contain excessive amounts of sugar and/or corn syrup, and/or do not contain an adequate supply of the RDA of key nutrients for this age group.

A proper balance of ingredients is important to the production of a nutritional bar meeting the RDA for teenagers. This should contain at least vitamins A, B12, E, chromium, zinc, selenium, folate, fat, protein, carbohydrates, and provide a specific amount of calories per mass or unit serving.

There is a need for nutritional bars for teenagers which can be formulated to provide high percentages of the RDA of supplements, nutrients, vitamins, and minerals as required by appropriate medical and governmental organizations for this age group. This bar should be easily adapted for human consumption, and should be capable of being specifically formulated to provide adequate amounts of vitamins, minerals, proteins, carbohydrates, etc. to teenagers and others having a deficiency in one or more of these materials. The bar should provide a minimum of 150 calories per 50 gram serving. Finally, there is a need for a nutrition bar that has taste, texture and mouth feel that is appealing to the teenage group of consumers.

### SUMMARY OF THE EMBODIMENTS

Thus, in an embodiment of the present invention is provided herein a food supplement, also commonly known as an energy bar, meal replacement, cereal bar, protein bar, diet bar, health bar, snack bar, or a nutrition bar, containing in one source a combination of the RDA for teenagers. The RDA for teenagers is generally regarded by the health professionals to include certain effective and nutritious amounts of at least some of the following materials (also referred to hereinafter as “nutrients”):

| | | | | |
|---|---|---|---|---|
| Fat | biotin | vitamin A | vitamin E | iron |
| Protein | choline | vitamin | vitamin K | calcium |
| | | B1(thiamine) | | |
| Carbohydrate | niacin | vitamin | selenium | chromium |
| | | B6 | | |
| Moisture | folate | vitamin | zinc | copper |
| | | B12 | | |
| Amino acids | pantothenic | vitamin C | manganese | fluorine |
| | acid | | | |
| Total fiber | riboflavin (B2) | vitamin D | magnesium | iodine |
| Molybdenum | phosphorus | | | |

The sources of these and other nutrients can vary, but in the present invention can include synthetic as well as natural products, such as honey, brown rice flakes, soy protein, semi-sweet chocolate (which contains sugar, chocolate liquor processed with alkali, cocoa, butter, butter fat, soy lecithin, vanillin, and natural flavors), defatted peanut flour, peanuts, peanut butter, natural and synthesized vitamins, and minerals or mineral sources.

Teenage boys and teenage girls have been determined to require different RDAs of certain nutrients relative to the amounts recommended or needed by infants, and young children as well as the requirements needed for young adults and even more mature adults. This is because the age group of approximately nine years old to about 20 years old experiences tremendous growth of various body systems, demonstrates execptional exertion of calories, and exhibits stress induced or at least exacerbated by, for example, elevated hormone levels. In addition, the RDA needs of teenage males can differ significantly in many nutrients from the RDA needs for females of the same age. Therefore, a need exists for a nutrition bar that can supply the specific dietary supplement needs of each age and gender consumer market.

The present invention therefore provides in an embodiment a nutrition bar or bars containing novel combinations of critical nutrients in effective, nutritious amounts while retaining desirable taste and consumer acceptance. More specifically, the present disclosure provides in one example a food composition comprising at least the RDA for teenage consumers of vitamins A, B12, E, chromium, zinc, selenium, folate, fat, protein, carbohydrates, and also provides at least 350 calories per 50 gram serving. In another embodiment, the percentage of total calories per 50 grams serving of the food composition is about 23% by weight from fat, 23% by weight from protein, and about 55% by weight from carbohydrates.

It is to be understood that both the foregoing general description and the following detailed description are exemplary and explanatory only and are intended to provide further explanation of the present invention, as claimed.

### DETAILED DESCRIPTION OF EMBODIMENTS

The present invention can be exemplified in several embodiments.

It has been discovered that an edible nutritional food, also referred to herein as a food composition, in the form of a solid, self-sustaining body can be produced that comprises a combination of nutrients particularly efficacious for teenagers, wherein the the food contains a nutritional makeup that coincides with at least the minimum of the healthy diet recommendations set forth by the USDA for Carbohydrates, Proteins and Fats. It has been recommended (by the American Academy of Pediatrics) that a healthy diet contains no more than ⅓ of its total calories from Fat or from Protein, yet still contains or possesses 100% of the RDA for adolescent and/or teenage males and females. Thus, the food composition of the present disclosure shall in an embodiment also have little to no trans fat, processed sugars, hydrogenated oils, artificial flavors or corn syrup. In one embodiment, this means less than about 10 gms of trans fat per 50 gram bar or serving. In another embodiment herein, the trans fat in less than about 2 gms per 50 gram bar or serving. And in yet another embodiment, there would be essentially no detectable trans fat in a 50 gram bar or serving.

Useful nutrients in an embodiment would be calcium, to aid in the formation of bone, iron, for growth production of blood and muscle building, Vitamin A, to help develop or improve vision, tissue and skin development, the B vitamins, for red blood cell formation, Vitamin C, to strengthen connective tissue, and vitamin D, for tooth and bone formation as well as to assist in calcium absorption.

In the present disclosure, “RDA” means recommended daily allowance as recommended by the U.S. food agencies, and “UL” means tolerable upper intake levels likely to pose no risk of adverse effects. “ND” means not determined. “IU” is International Units.

According to U.S. Department of Agriculture-Food Guide Pyramid recommended total calories to be consumed per day for active teens are as follows:

| | |
|---|---|
| Males 9-13 | 2,800 calories |
| Males 14-19 | 2,800 calories |
| Females 9-13 | 2,200 calories |
| Females 14-19 | 2,200 calories |

Preferred RDAs of various nutrients for males and females have been identified herein for the following age groups of 9-13 years of age and 14-19 years of age:

| | | |
|---|---|---|
| Nutrient | RDA/day | UL/day |

Males 9-13

| Calcium | 1300 | mg | 2500 | mg |
|---|---|---|---|---|
| Chromium | 25 | μg | ND | |
| Copper | 700 | μg | 5,000 | μg |
| Fluoride | 2 | mg | 10 | mg |
| Iodine | 120 | μg | 600 | μg |
| Iron | 8 | mg | 40 | mg |
| Magnesium | 240 | mg | 350 | mg |
| Manganese | 1.9 | mg | 6 | mg |
| Molybdenum | 34 | μg | 1,100 | μg |
| Nickel | ND | | 0.6 | mg |
| Phosphorus | 1250 | mg | 4000 | mg |
| Selenium | 40 | μg | 280 | μg |
| Zinc | 8 | mg | 23 | mg |
| Carbohydrate | 130 | g | — | |
| Total fiber | 31 | g | — | |
| Total fat | ND | | — | |
| Poly.unsat. fatty acids (n − 6) | 12 | g | — | |
| Poly.unsat. fatty acids (n − 3) | 1.2 | g | — | |
| Protein | 34 | g | — | |
| Histidine | 18 | mg | — | |
| Isoleucine | 25 | mg | — | |
| Lysine | 55 | mg | — | |
| Leucine | 51 | mg | — | |
| Methionine/cysteine | 25 | mg | — | |
| Phenylalanine/tyrosine | 47 | mg | — | |
| Threonine | 27 | mg | — | |
| Tryptophan | 7 | mg | — | |
| Valine | 32 | mg | — | |
| Biotin | 20 | μg | ND | |
| Choline | 375 | mg | 2000 | mg |
| Folate | 300 | μg | 600 | μg |
| Niacin | 12 | mg | 20 | mg |
| Pantothenic acid | 4 | mg | ND | |
| Riboflavin (B2) | 0.9 | mg | ND | |
| Thiamin (B1) | 0.9 | mg | ND | |
| Vitamin A | 600 | μg | 1700 | μg |
| Vitamin B6 | 1.0 | mg | 60 | mg |
| Vitamin B12 | 1.3 | μg | ND | |
| Vitamin C | 45 | mg | 1200 | mg |
| Vitamin D | 5 | μg | 50 | μg |
| Vitamin E | 11 | mg | 600 | mg |

| | | | |
|---|---|---|---|
| Vitamin K | 60 | μg | ND |

Males 14-19

| Calcium | 1300 | mg | 2500 | mg |
|---|---|---|---|---|
| Chromium | 35 | μg | ND | |
| Copper | 890 | μg | 8000 | μg |
| Fluoride | 3 | mg | 10 | mg |
| Iodine | 150 | μg | 900 | μg |
| Iron | 11 | mg | 45 | mg |
| Magnesium | 410 | mg | 350 | mg |
| Manganese | 2.2 | mg | 9 | mg |
| Molybdenum | 43 | μg | 1700 | μg |
| Nickel | ND | | 1.0 | mg |
| Phosphorus | 1250 | mg | 4000 | mg |
| Selenium | 55 | μg | 4000 | μg |
| Zinc | 11 | mg | 34 | mg |
| Carbohydrate | 130 | g | — | |
| Total fiber | 38 | g | — | |
| Total fat | ND | | — | |
| Poly.unsat. fatty acids (n − 6) | 16 | g | — | |
| Poly.unsat. fatty acids (n − 3) | 1.6 | g | — | |
| Protein | 52 | g | — | |
| Histidine | 18 | mg | — | |
| Isoleucine | 25 | mg | — | |
| Lysine | 55 | mg | — | |
| Leucine | 51 | mg | — | |
| Methionine/cysteine | 25 | mg | — | |
| Phenylalanine/tyrosine | 47 | mg | — | |
| Threonine | 27 | mg | — | |
| Tryptophan | 7 | mg | — | |
| Valine | 32 | mg | — | |
| Biotin | 25 | μg | ND | |
| Choline | 550 | mg | 3000 | mg |
| Folate | 400 | μg | 800 | μg |
| Niacin | 16 | mg | 30 | mg |
| Pantothenic acid | 5 | mg | ND | |
| Riboflavin (B2) | 1.3 | mg | ND | |
| Thiamin (B1) | 1.2 | mg | ND | |
| Vitamin A | 900 | μg | 2800 | μg |
| Vitamin B6 | 1.3 | mg | 80 | mg |
| Vitamin B12 | 2.4 | μg | ND | |
| Vitamin C | 75 | mg | 1800 | mg |
| Vitamin D | 5 | μg | 50 | μg |
| Vitamin E | 15 | mg | 800 | mg |

| | | | |
|---|---|---|---|
| Vitamin K | 75 | μg | ND |

Females 9-13

| Calcium | 1300 | mg | 2500 | mg |
|---|---|---|---|---|
| Chromium | 21 | μg | ND | |
| Copper | 700 | μg | 5000 | μg |
| Fluoride | 2 | mg | 10 | mg |
| Iodine | 120 | μg | 600 | μg |
| Iron | 8 | mg | 40 | mg |
| Magnesium | 240 | mg | 350 | mg |
| Manganese | 1.6 | mg | 6 | mg |
| Molybdenum | 43 | μg | 1100 | μg |
| Nickel | ND | | 0.6 | mg |
| Phosphorus | 1250 | mg | 4000 | mg |
| Selenium | 40 | μg | 280 | μg |
| Zinc | 8 | mg | 23 | mg |
| Carbohydrate | 130 | g | — | |
| Total fiber | 26 | g | — | |
| Total fat | ND | | — | |
| Poly.unsat. fatty acids (n − 6) | 10 | g | — | |
| Poly.unsat. fatty acids (n − 3) | 1.0 | g | — | |
| Protein | 34 | g | — | |
| Histidine | 18 | g | — | |
| Isoleucine | 25 | g | — | |
| Lysine | 55 | g | — | |
| Leucine | 51 | g | — | |
| Methionine/cysteine | 25 | g | — | |
| Phenylalanine/tyrosine | 47 | g | — | |
| Threonine | 27 | g | — | |
| Tryptophan | 7 | g | — | |
| Valine | 32 | g | — | |
| Biotin | 20 | μg | ND | |
| Choline | 375 | mg | 2000 | mg |
| Folate | 300 | μg | 600 | μg |
| Niacin | 12 | mg | 20 | mg |
| Pantothenic acid | 4 | mg | ND | |
| Riboflavin (B2) | 0.9 | mg | ND | |
| Thiamin (B1) | 0.9 | mg | ND | |
| Vitamin A | 600 | μg | 1700 | μg |
| Vitamin B6 | 1.0 | mg | 60 | mg |
| Vitamin B12 | 1.8 | μg | ND | |
| Vitamin C | 45 | mg | 1200 | mg |
| Vitamin D | 5 | μg | 50 | μg |
| Vitamin E | 11 | mg | 600 | mg |

| | | | |
|---|---|---|---|
| Vitamin K | 60 | μg | ND |

Females 14-19

| Calcium | 1300 | mg | 2500 | mg |
|---|---|---|---|---|
| Chromium | 24 | μg | ND | |
| Copper | 890 | μg | 8000 | μg |
| Fluoride | 3 | mg | 10 | mg |
| Iodine | 150 | μg | 900 | μg |
| Iron | 15 | mg | 45 | mg |
| Magnesium | 360 | mg | 350 | |
| Manganese | 1.6 | mg | 9 | mg |
| Molybdenum | 43 | μg | 1700 | μg |
| Nickel | ND | | 1.0 | mg |
| Phosphorus | 1250 | mg | 4000 | mg |
| Selenium | 55 | μg | 400 | μg |
| Zinc | 9 | mg | 34 | mg |
| Carbohydrate | 130 | g | — | |
| Total fiber | 26 | g | — | |
| Total fat | ND | | — | |
| Poly.unsat. fatty acids (n − 6) | 11 | g | — | |
| Poly.unsat. fatty acids (n − 3) | 1.1 | g | — | |
| Protein | 46 | g | — | |
| Histidine | 18 | mg | — | |
| Isoleucine | 25 | mg | — | |
| Lysine | 55 | mg | — | |
| Leucine | 51 | mg | — | |
| Methionine/cysteine | 25 | mg | — | |
| Phenylalanine/tyrosine | 47 | mg | — | |
| Threonine | 27 | mg | — | |
| Tryptophan | 7 | mg | — | |
| Valine | 32 | mg | — | |
| Biotin | 25 | mg | ND | |
| Choline | 550 | mg | 3500 | mg |
| Folate | 400 | μg | 1000 | μg |
| Niacin | 14 | mg | 30 | mg |
| Pantothenic acid | 5 | mg | ND | |
| Riboflavin (B2) | 1.0 | mg | ND | |
| Thiamin (B1) | 1.0 | mg | ND | |
| Vitamin A | 700 | μg | 2800 | μg |
| Vitamin B6 | 1.2 | mg | 80 | mg |
| Vitamin B12 | 2.4 | μg | ND | |
| Vitamin C | 65 | mg | 1800 | mg |
| Vitamin D | 5 | μg | 50 | μg |
| Vitamin E | 15 | mg | 800 | mg |

| | | | |
|---|---|---|---|
| Vitamin K | 75 | μg | ND |

Some of the above values were based on 0.95 g/kg/day for 4-13 year olds, and 0.85 g/kg/day for 14-19 year olds. The above amounts therefore present a range from the RDA up to about the UL specific nutrient consumption by teenage boys and girls per day.

Thus, the present invention in one embodiment provides a chocolate nutrition bar or food composition comprising in an approximately 50 gram sample: soy protein, honey, 185-200 calories, essentially no detectable trans fat, no processed sugars, no hydrogenated oils, no artificial flavours, no corn syrup, 585 mg to 910 mg calcium, and 0.8 mg to 1.6 mg iron. In another embodiment is provided a peanut nutrition bar or food composition comprising in an approximately 50 gram sample: 200-230 calories, essentially no detectable trans fat, no processed sugars, no hydrogenated oils, no artificial flavours, no corn syrup, and 585 mg to 910 mg calcium, and 0.8 mg to 1.6 mg iron. These nutrition bars or food compositions provide in an approximately 50 grams sample 100% of the RDA for the recited nutrients, and when prepared according to the process described herein, have a taste and texture that is acceptable to teenage consumers. In one embodiment for males aged 9-13, this nutrition bar or food composition provides 195-198 calories in a 50 gram serving. In an embodiment for males aged 14-19, this nutrition bar or food composition provides 190-205 calories in a 50 gram serving. In one embodiment for females aged 9-13, this nutrition bar or food composition provides 190-200 calories in a 50 gram serving. In an embodiment for females aged 14-19, this nutrition bar or food composition provides 195-200 calories in a 50 gram serving.

In another example provided herein is a food composition consisting essentially of a filler selected from at least one material of the group of materials including rice, soy, and peanut flour, said composition further consisting essentially of the RDA for teenage consumers of vitamins A, B12, E, chromium, zinc, selenium, folate, fat, protein, carbohydrates, wherein said composition further provides said teenage consumer of said composition at least 200 calories per 50 gram of said food composition, and wherein the percentage of total calories per 50 grams serving of the food composition is about 23% by weight from fat, 23% by weight from protein, and 55% by weight from carbohydrates. In an embodiment, the vitamin A content exceeds about 600 micrograms (μg), the vitamin B12 content exceeds about 1.3 μg, the vitamin E content exceeds about 11 milligrams (mg), the chromium content exceeds about 21 μg, the zinc content exceeds about 8 mg, the selenium content exceeds about 40 μg, the folate content exceeds about 300 μg, the total protein carbohydrate content exceeds about 34 grams (gm), and the total carbohydrate content exceeds about 130 gm.

More specifically, another useful form of the present invention for consumption by teenagers has at least the following amounts of the following materials: vitamin A (as palmitate) 5000 IU, vitamin D3 (as cholecalciferol) 400 IU, vitamin E (as acetate) 30 IU, biotin 0.3 mg, folic acid 0.4 mg, niacin (as niacinamide) 20 mg, pantothenic acid (as D-calcium pantothenate) 10 mg, vitamin B1 (as thiamine mononitrate) 1.5 mg, vitamin B12 (as cyanocobalamine) 6 mcg, vitamin B2 (as riboflavin) 1.7 mg, vitamin B6 (as pyridoxine HCl) 2 mg, vitamin C (as ascorbic acid) 60 mg, copper (as copper gluconate) 2 mg, iodine (as potassium iodide) 0.15 mg, iron (as electrolytic iron) 18 mg, zinc (as zinc oxide) 15 mg, and dicalcium phosphate Q.S. These materials can in one embodiment be combined in any order and by any means to form a vitamin premix formulation. By “vitamin premix” herein is meant a combination of two or more of the aforementioned vitamins and/or minerals or elements. For the purpose of defining the “vitamin premix”, the non-vitamin components, such as minerals and elements, are to be included within “vitamin premix”. The vitamin premix formulation can then be further combined in any of several manners with fillers, chocolate, honey, rice or soy, peanuts, and/or flour.

Another embodiment herein provides a food composition comprising 0.5 wgt % to 1.0 wgt % of the aforementioned vitamin premix formulation which has been combined with 20-40 wgt % of honey, 5 wgt % to 10 wgt % of flat soy grits, 20 wgt % to 30 wgt % of soy protein, 10 wgt % to 15 wgt % of peanut flour (such as but not limited to golden peanut flour), 7 wgt % to 9 wgt % of unsalted (whole, cut or crushed) peanuts, and 13 wgt % to 18 wgt % peanut butter. The ingredients can be mixed thoroughly with some optional warming if desired to improve flow, but without the necessity of cooking. The formulation can then be cut, pressed, rolled or stamped into desired sizes or shapes, including for example and not as a limitation herein single bite-sized bits of approximately one half to one inch on a side, up to for example, 3 to 6 inch length bars with a width of 1 to 3 inches.

Thus, in one embodiment herein is presented a bar or food composition that is approximately one half to one inch thick, one inch to three inches wide, and one inch to six inches in length, having approximately 4 calories per gram, and providing 100% of the RDA for the following nutrients: Vitamins; A, D3, E, B1, B12, B2, B6, C, Biotin, Folic Acid, Pantothenic Acid, Niacin, Copper, Iodine, Zinc, Iron and Dicalcium Phosphate.

Conventional nutrition and health bars often have level of salt (sodium chloride) that for some age groups or medical conditions would be undesirable, but such levels are used to achieve taste. Therefore, in one embodiment of the present invention is presented a nutrition bar or food composition that has less than 150 mg of sodium chloride per 50 gm of the bar or composition. Further, a total sodium content of less than 175 mg, or in another example, of less than 200 mg is provided by the present invention.

The following examples further illustrate aspects of the present invention but do not limit the present invention.

A further embodiment provides a food composition in the form of a solid, self-sustaining body comprising per approximately 50 gram sample: soy protein, honey, 185-200 calories, essentially no detectable trans fat, no processed sugars, no hydrogenated oils, no artificial flavours, no corn syrup, 585 mg to 910 mg calcium, and 0.8 mg to 1.6 mg iron.

In the health food and nutritional supplement markets, it is also important to clearly identify and distinguish the desired target consumer group with proper marking, advertising, graphics, labelling, instructions, and/or packaging, all referred to herein as indicia.

Therefore, another embodiment herein provides an edible nutritional food in the form of a solid, self-sustaining body contained in packaging marked with indicia directed toward consumption of the food by a male or female between the ages of nine years old and nineteen years old. More specifically, herein is provided an edible nutritional food in the form of a solid, self-sustaining body contained in packaging marked with indicia directed toward consumption of the food by a male between the ages of nine years old and thirteen years old, wherein the food comprises soy protein, honey, no artificial flavors, no trans fat, no hydrogenated oils, and 100% of the RDA for a male between the ages of nine years old and thirteen years old as presently taught herein.

Still another embodiment herein provides an edible nutritional food in the form of a solid, self-sustaining body contained in packaging marked with indicia directed toward consumption of the food by a male between the ages of thirteen years old and nineteen years old, wherein the food comprises soy protein, no artificial flavors, no trans fat, no hydrogenated oils, and 100% of the RDA for a male between the ages of thirteen years old and nineteen years old as presently taught herein.

Another embodiment herein provides an edible nutritional food in the form of a solid, self-sustaining body contained in packaging marked with indicia directed toward consumption of the food by a female between the ages of nine years old and thirteen years old, wherein the food comprises soy protein, no artificial flavors, no trans fat, no hydrogenated oils, and 100% of the RDA for a female between the ages of nine years old and thirteen years old as presently taught herein.

Still another embodiment herein provides an edible nutritional food in the form of a solid, self-sustaining body contained in packaging marked with indicia directed toward consumption of the food by a female between the ages of thirteen years old and nineteen years old, wherein the food comprises soy protein, no artificial flavors, no trans fat, no hydrogenated oils, and 100% of the RDA for a female between the ages of thirteen years old and nineteen years old as presently taught herein.

It has been determined that one nutrition bar characteristic desired by the teenage consumer is a specific texture and firmness sufficient to render the food biteable, chewable, and yet self-sustaining. By “self-sustaining” herein is meant the food composition is not limp, or does not sag under its own weight, and does not crumble apart or easily disintegrate outside the consumer's mouth.

In another embodiment herein, an edible food bar is provided that weighs about 10 to about 100 grams, and in another embodiment weighs about 40 to 60 grams, and contains 25 grams of carbohydrates, 12 grams of protein, and 6 grams of fat. These amounts constitute approximately 100% of the RDA for males 13-19 years old and approximately 100% of the RDA for females 13-19 years old.

In one embodiment herein the desirable taste sought by teenage consumers is achieved by using as a sweetener in the food composition a sufficient amount of honey, a well regarded natural source of sweetness. Thus, for example, 20-40% by weight honey, or 30% by weight honey, is very useful, and said quantities of honey also provide the food compositions taught herein with acceptable texture, consumer handling capability, mouth feel, and adhesion of the other components. Honey, used in the amounts described, also facilitates easier blending, extruding, shaping and/or cutting of the food compositions described herein to form, for example, bars, cubes, or rolled comestibles.

Another example of the present disclosure is a nutrition bar comprising 30-40% by weight honey, 8-15% by weight soy grits, 10-20% by weight soy protein, 5-10% by weight peanut flour, 5-8% by weight unsalted peanuts, 10-15% by weight peanut butter, and 1-3% by weight of vitamins and/or minerals selected from the group consisting of vitamin A, vitamin B6, vitamin B12, calcium, chromium, manganese, and phosphorus, wherein the vitamins and minerals provide 100% of the RDA. The vitamin and mineral content can in one 50 gram embodiment be, for example, 600 to 3000 micrograms of vitamin A, 1 mg to 100 mg of vitamin B6, 1.7 μg to 5.0μg of vitamin B12, 1300 to 2500 mg of calcium, 21 to 30 μg of chromium, 1.6 to 10 mg of manganese, and 1200 to 4500 mg of phosphorus. In one embodiment of this example, the chocolate bar provides about 185-205 calories per 50 grams of nutrition bar, and in another peanut embodiment provides 200-230 calories per 50 grams. Of the total calories per 50 gram serving in one example, about 20% of the calories come from fat, about 20% of the calorie comes from protein, and about 60% of the calories come from the carbohydrates. This composition has been shown to have a pleasant and teen-acceptable taste while providing the RDA for the age group.

Another example of the present invention would include a food bar, wherein in a 50 gram sample the vitamin A is present in an amount of from 600 to 2800 micrograms, the vitamin B6 is present in an amount of from 1.0 milligram to 80 milligrams, vitamin C is present in an amount of from 45 milligrams to 180 milligrams, calcium is present in an amount of from 130 to 2500 milligrams, copper is present in an amount of from 700 micrograms to 8000 micrograms, manganese is present in an amount of from 1.6 millligrams to 350 milligrams, and phosphorus is present in an amount of from 1250 milligrams to 4000 miligrams.

In another example, of the present disclosure is a nutrition bar comprising or consisting essentially of 25-35% by weight honey, 20-30% by weight soy protein, 15-25% by weight rice flakes, 10-20% by weight chocolate chips (containing sugar, chocolate liquor, cocoa butter, milk fat, soy lecithin, vanillin, and flavor), and 1-3% by weight of vitamins and/or minerals selected from the group consisting of vitamin A, vitamin B6, vitamin B12, calcium, chromium, manganese, and phosphorus. In one embodiment of this example, the bar provides about 170-200 calories per 50 grams of nutrition bar. Of the total calories per 50 gram serving, 20% of the calories come from fat, 20% of the calorie comes from protein, and 60% of the calories come from the carbohydrates. This composition has also been shown to have a pleasant and teen-acceptable taste while providing the RDA for the age group.

Another embodiment provided here is a method of manufacturing a food composition, said method combining in any order soy protein crisps, honey, unsalted peanuts, peanut butter, peanut flour, semi-sweet chocolate, and vitamin premix containing vitamin A, vitamin B6, vitamin B12, calcium, chromium, manganese, and phosphorus, to form a mass, and compacting, shaping, extruding, stamping, or cutting said mass to form a self-sustaining body, and optionally heating said body.

In another embodiment is provided herein a method of manufacturing a food composition, said method comprising, or in a more narrow form, consisting of combining in any order materials selected from the group consisting of honey, soy protein crisps, vitamin premix, and semisweet chocolate to thereby form a food mass, and optionally compacting, shaping, extruding, stamping, or cutting said mass to form a desired size/shape, and, optionally, heating said mass at a temperature and for a time sufficient to cook, gelatinize, reduce the water content, and/or denature proteins contained therein.

In another embodiment herein, there is no need to heat or cook the composition, and simply blending the vitamin premix formulation described hereinabove containing the RDA for teenagers and then combining the vitamin premix formulation with honey, rice, nuts, and flour will produce the food composition with taste and texture acceptable to teenage consumers, while still providing the desired nutritional and caloric delivery.

In another embodiment, no corn syrup or fructose is added to the food composition or combined with the vitamin premix formulation. In this or another embodiment, no processed or refined sugar is added, although chocolate flavoring which can contain some sugar may be ueful. Artificial sweeteners can be excluded in certain formulations herein if desired.

### EXAMPLES

### Example 1

A food composition can be prepared by forming a vitamin premix containing the RDA of vitamins and minerals listed hereinabove for males aged 13-19 years old. In a food composition for males aged 9-13 years old, the vitamin premix can be combined in any order using known mixing or blending techniques. The vitamin premix is then combined with 15 wgt % peanut butter, 13.3 wgt % peanut flour, 8.4 wgt % unsalted roasted peanuts, and 7.5 wgt % flat soy grits to produce a mixture. The mixture is spread 1-2 inch thick on to a surface and allowed to briefly settle and/or cool, if the vitamin premix had been warmed. The mixture is cut into food composition bars approximately 2 inches wide by 6-8 inches long.

### Example 2

A food composition can be prepared by forming a vitamin premix containing the RDA of vitamins and minerals listed hereinabove for adolescent females aged 9 to 13 years old. In a food composition for females aged 9-13 years old, the vitamin premix can be combined in any order using known mixing or blending techniques. The vitamin premix is then combined with 15 wgt % peanut butter, 13.3 wgt % peanut flour, 8.4 wgt % unsalted roasted peanuts, and 7.5 wgt % flat soy grits to produce a mixture. The mixture is spread 1-2 inch thick on to a surface and allowed to briefly settle and/or cool, if the vitamin premix had been warmed. The mixture is cut into food composition bars approximately 2 inches wide by 6-8 inches long.

### Example 3

A food composition is presented in which a 50 gram sample or serving size has 200 calories, 70 of which come from fat, 8 grams of total fat, 1 gram of saturated fat, zero grams cholesterol, 180 mg sodium, 18 gm total carbohydrate, 2 gm dietary fiber, 13 gm sugars, 17 gm protein, and 100% of the RDA for vitamin A and vitamin C, 40% of the RDA for calcium, and 120% of the RDA for iron.

### Example 4

A food composition is presented in which a 50 gram sample or serving size has 200 calories, 45 of which come from fat, 5 grams of total fat, 3 gram of saturated fat, zero grams cholesterol, 150 mg sodium, 26 gm total carbohydrate, 1 gm dietary fiber, 23 gm sugars, 12 gm protein, and 100% of the RDA for vitamin A and vitamin C, 60% of the RDA for calcium, and 120% of the RDA for iron.

Other embodiments of the present invention will be apparent to those skilled in the art from consideration of the specification and practice of the invention disclosed herein. As used throughout the specification and claims, “a” and/or “an” may refer to one or more than one. Unless otherwise indicated, all numbers expressing quantities of ingredients, properties such as molecular weight, percent, ratio, reaction conditions, and so forth used in the specification and claims are to be understood as being modified in all instances by the term “about.” Accordingly, unless indicated to the contrary, the numerical parameters set forth in the specification and claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. It is intended that the specification and examples be considered as exemplary only, with a true scope and spirit of the invention being indicated by the following claims. It is to be understood that the reactants and components referred to by chemical name anywhere in the specification or claims hereof, whether referred to in the singular or plural, are identified as they exist prior to coming into contact with another substance referred to by chemical name or chemical type (e.g., solvent, etc.). It matters not what chemical changes, transformations and/or reactions, if any, take place in the resulting mixture or solution or reaction medium as such changes, transformations and/or reactions are the natural result of bringing the specified reactants and/or components together under the conditions called for pursuant to this disclosure. Accordingly, even though the claims hereinafter may refer to substances, components and/or ingredients in the present tense (“comprises”, “is”, etc.), the reference is to the substance, components or ingredient as it existed at the time just before it was first blended or mixed with one or more other substances, components and/or ingredients in accordance with the present disclosure. The fact that the substance, components or ingredient may have lost its original identity through a chemical reaction or transformation during the course of such blending or mixing operations or immediately thereafter is thus wholly immaterial for an accurate understanding and appreciation of this disclosure and the claims thereof.

This invention is susceptible to considerable variation in its practice. Therefore the foregoing description is not intended to limit, and should not be construed as limiting, the invention to the particular exemplifications presented hereinabove. Rather, what is intended to be covered is as set forth in the ensuing claims and the equivalents thereof permitted as a matter of law.

Applicant does not intend to dedicate any disclosed embodiments to the public, and to the extent any disclosed modifications or alterations may not literally fall within the scope of the claims, they are considered to be part of the invention under the doctrine of equivalents.

What is claimed is:

1. A food composition in the form of a solid, self-sustaining body comprising per approximately 50 gram sample: soy protein, honey, 185-200 calories, essentially no detectable trans fat, no processed sugars, no hydrogenated oils, no artificial flavours, no corn syrup, 585 mg to 910 mg calcium, and 0.8 mg to 1.6 mg iron.

2. A composition comprising 20 to 25 grams of carbohydrate, 10 to 12 grams of protein, 0 to 1 gram of saturated fat, 0 to 5 grams of unsaturated fat, 1300 to 2500 milligrams of calcium, and 600 to 2800 micrograms of vitamin A.

3. A composition comprising 20 to 22 grams of carbohydrate, 16 to 20 grams of protein, 0 to 1 gram of saturated fat, 5 to 7 grams of unsaturated fat, 240 to 350 milligrams of magnesium, and 700 to 8000 micrograms of copper.

4. A composition comprising 20 to 25 grams of carbohydrate, 12 to 16 grams of protein, 0 to 1 gram of saturated fat, 0 to 5 grams of unsaturated fat, 45 milligrams to 1800 milligrams of vitamin C, and 5 to 50 micrograms of vitamin D.

5. A composition consisting essentially of, in a 50 gram sample, 20 to 25 grams of carbohydrate, 10 to 20 grams of protein, 0.1 to 1 gram of saturated fat, 0.1 to 5 grams of unsaturated fat.

6. A food composition in the form of a solid, self-sustaining body contained in packaging marked with indicia directed toward consumption of said food by a male between the ages of nine years old and thirteen years old, said packaged food comprising: soy protein, honey, no artificial flavors, no trans fat, no hydrogenated oils, and 100% of the RDA for a male between the ages of nine years old and thirteen years old.

7. A food composition in the form of a solid, self-sustaining body contained in packaging marked with indicia directed toward consumption of said food by a male between the ages of thirteen years old and nineteen years old, said packaged food comprising soy protein, honey, no artificial flavors, no trans fat, no hydrogenated oils, and 100% of the RDA for a male between the ages of thirteen years old and nineteen years old

8. A food composition in the form of a solid, self-sustaining body contained in packaging marked with indicia directed toward consumption of said food by a female between the ages of nine years old and thirteen years old, said pckaged food comprising soy protein, honey, no artificial flavors, no trans fat, no hydrogenated oils, and 100% of the RDA for a female between the ages of nine years old and thirteen years old.

9. A food composition in the form of a solid, self-sustaining body contained in packaging marked with indicia directed toward consumption of said food by a female between the ages of thirteen years old and nineteen years old, said packaged food comprising soy protein, honey, no artificial flavors, no trans fat, no hydrogenated oils, and 100% of the RDA for a male between the ages of thirteen years old and nineteen years old.

10. A method of manufacturing a food composition, said method comprising combining in any order soy protein crisps, honey, unsalted peanuts, peanut butter, peanut flour, semi-sweet chocolate, and vitamin premix containing vitamin A, vitamin B6, vitamin B12, calcium, chromium, manganese, and phosphorus, to form a mass, and
compacting, shaping, extruding, stamping, or cutting said mass to form a self-sustaining body, and optionally heating said body.

11. The method of claim 10, wherein said heating is at a temperature and for a time sufficient to gelatinize said body.

12. The method of claim 10, wherein said heating is at a temperature and for a time sufficient to reduce the water content of said body.

13. The method of claim 10, wherein said heating is at a temperature and for a time sufficient to denature proteins contained in said body.

14. A nutrition bar comprising 30-40% by weight honey, 20-30% by weight rice flakes, 10-20% by weight soy protein, 5-15% by weight semi-sweet chocolate, 5-10% by weight peanut flour, 2-3% by weight unsalted peanuts, 2-3% by weight peanut butter, and 1-3% by weight of vitamins and minerals selected from the group consisting of vitamin A, vitamin B6, vitamin B12, calcium, chromium, manganese, and phosphorus.

15. The bar of claim 14, wherein in a 50 gram sample the vitamin A is present in an amount of from 600 to 2800 micrograms, the vitamin B6 is present in an amount of from 1.0 milligram to 80 milligrams, vitamin C is present in an amount of from 45 milligrams to 180 milligrams, calcium is present in an amount of from 130 to 2500 milligrams, copper is present in an amount of from 700 micrograms to 8000 micrograms, manganese is present in an amount of from 1.6 millligrams to 350 milligrams, and phosphorus is present in an amount of from 1250 milligrams to 4000 miligrams.

16. A nutrition bar comprising 25-35% by weight honey, 20-30% by weight soy protein, 15-25% by weight rice flakes, 10-20% by weight chocolate chips (containing sugar, chocolate liquor, cocoa butter, milk fat, soy lecithin, vanillin, and flavor), and 1-3% by weight of vitamins and/or minerals selected from the group consisting of vitamin A, vitamin B6, vitamin B12, calcium, chromium, manganese, and phosphorus.

17. A food composition comprising the RDA for teenage consumers of vitamins A, B12, E, chromium, zinc, selenium, folate, protein, carbohydrates, wherein said composition further provides said teenage consumer of said composition at least 350 calories per 50 gram of said food composition, and wherein the percentage of total calories per 50 grams serving of the food composition is about 23% by weight from fat, 23% by weight from protein, and 55% by weight from carbohydrates.

18. The food composition of claim 17, wherein the vitamin A content exceeds about 600 micrograms (μg), the vitamin B12 content exceeds about 1.3 μg, the vitamin E content exceeds about 11 milligrams (mg), the chromium content exceeds about 21 μg, the zinc content exceeds about 8 mg, the selenium content exceeds about 40 μg, the folate content exceeds about 300 μg, the total protein carbohydrate content exceeds about 34 grams (gm), and the total carbohydrate content exceeds about 130 gm.

19. A food composition consisting essentially of a filler selected from at least one material of the group of materials including rice, soy, and peanut flour, said composition further consisting essentially of the RDA for teenage consumers of vitamins A, B12, E, chromium, zinc, selenium, folate, fat, protein, carbohydrates, wherein said composition further provides said teenage consumer of said composition at least 350 calories per 50 gram of said food composition, and wherein the percentage of total calories per 50 grams serving of the food composition is about 23% by weight from fat, 23% by weight from protein, and 55% by weight from carbohydrates.

20. A nutrition bar comprising 30-40% by weight honey, 8-15% by weight soy grits, 10-20% by weight soy protein, 5-10% by weight peanut flour, 5-8% by weight unsalted peanuts, 10-15% by weight peanut butter, and 1-3% by weight of vitamins and/or minerals selected from the group consisting of vitamin A, vitamin B6, vitamin B12, calcium, chromium, manganese, and phosphorus, wherein the vitamins and/or minerals provide 100% of the recommended daily allowance.

21. A food composition comprising 0.5 wgt % to 1.0 wgt % of a vitamin premix formulation, 20-40 wgt % of honey, 5 wgt % to 10 wgt % of flat soy grits, 20 wgt % to 30 wgt % of soy protein, 10 wgt % to 15 wgt % of peanut flour, 7 wgt % to 9 wgt % of unsalted peanuts, and 13 wgt % to 18wgt % peanut butter.
